(19) United States
(12) Patent Application Publication
(10) Pub. No.: US 2005/0256877 A1
(43) Pub. Date: Nov. 17, 2005

(54) 3-Dimensional realm for internet shopping

(76) Inventors: David Searles, Tucson, AZ (US); Louis Ascencio, Tucson, AZ (US); Chris Mashburn, Tucson, AZ (US)

Correspondence Address: Mark E. Ogram, Ste 203, 7454 E. Broadway, Tucson, AZ, 85710, US

(21) Appl. No.: 10/846,990

(22) Filed: May 13, 2004

(51) Int. Cl. G06F 7/00

(52) U.S. Cl. 707/10

(57) ABSTRACT

A network of computers in which multiple remote computers communicate between each other. A first computer is able to connect to a second computer and access a virtual building having a plurality of virtual items within said virtual building. Each of the virtual items has a specific location within said virtual building. The user is able to “browse” through the virtual building “shopping” for items within the virtual building until a purchase is wanted. The user is also able to see and converse with other users “within” the virtual building.

### BACKGROUND OF THE INVENTION

This invention relates generally to the Internet and other distributed computer systems, and more particularly to commerce upon such distributed computer systems.

Within this discussion, the Internet will be referenced, but the invention is not limited solely to this distributed network, rather, the invention is intended for use on any network of computers in which remote computers are able to selectively engage with each other.

The Internet has created a realm which only twenty years ago would have been unthinkable. With the Internet, users are able to find references, access auctions and make bids on goods, shop on catalog arrangements from “brick and mortar” stores, engage in games with remote users, transmit instant messages and e-mails, and a host of other activities.

To say the Internet has changed everyday life would be an understatement, and with these changes, the lives of the users are made easier and more informed. This is particularly true in the area of shopping where goods/services are easily obtained using both auctions and catalogs.

In either case, auction or catalogs, the user is able to access Internet “pages” which give a description of the goods/services, their characteristics, and a purchase price. With a click of a button, the user is able to place the order.

Unfortunately, the user often has a question about the goods/services which is not addressed in the catalog listing or the user wants to obtain another user's opinion on the goods/services. In this case, the user must access another “page” and/or transmit an e-mail to the company's personnel who will reply to the specific question. As can be appreciated, this response takes a great deal of time and often in the interim the user changes from a potential customer to someone who is mildly interested and a sale is lost.

It is clear there is a tremendous need for an improved commercial setting for the Internet.

### SUMMARY OF THE INVENTION

Within the following discussion, the term “virtual” refers to a computer simulated item, whether it is a building, an item within the building, or a representation of a user within the virtual building. While the presentation on the monitor is 2-dimensional, the image appears to be 3-dimensional allowing the view to “move” through the room simulating a 3-dimensional experience.

The present invention operates on a network of computers in which multiple remote computers communicate between each other. In this context, a first computer provides input as to the user's desires or choices. This data is sent to the second computer which serves as a “host” for the program and operation based upon the input data from the first computer.

Within this invention, the first computer is able to connect to a second computer and access a virtual building. The second computer contains a memory which defines this virtual building. Additionally, the virtual building has a plurality of virtual items therein.

These items include such things as: paintings, furniture, automobiles, travel flyers, movies, and a host of other items obvious to those of ordinary skill in the art.

Those of ordinary skill in the art recognize a variety of techniques which can be used to create the virtual building and virtual items. Some such techniques are described in: U.S. Pat. No. 6,728,317, issued Apr. 27, 2004, to Demos and entitled, “Moving Image Compression Quality Enhancement Using Displacement Filters with Negative Lobes”; and, U.S. Pat. No. 6,728,679, issued Apr. 27, 2004, to Stribbe et al. and entitled, “Self-Updating User Interface/entertainment Device that Simulates Personal Interaction”; both of which are incorporated hereinto by reference.

Each of the virtual items has a specific location within the virtual building. This means that not all of the items are visible within a single specific view into the virtual building. The user of the first computer provides input as to their desired “movement” within the virtual building with the ability to “browse” through thousands of pictures, not just view a static page.

In this manner, the user is able to “browse” through the virtual building “shopping” for the items within the virtual building until a purchase is wanted. Using the example of an art gallery, the user is able to move through the various rooms and visualize the various pieces of art. In the case of a painting, the painting is “hung” on a wall; but, in the case of a sculpture, the sculpture is placed on a pedestal or encasement allowing the user of the first computer to “move” around the sculpture and view it from different angles.

Through a variety of techniques, “mood music” is also available including the clinking of glasses and murmuring during the art gallery opening.

In one embodiment of the invention, the user of the first computer is able to “see” other visitors within the virtual building. These visitors, together with the first computer's user, are represented by a “likeness” or “avator” (ideally chosen by the user of the computer). If another user's likeness is “proximate” to the first computer's user, the user is able to converse with the other user through instant messaging techniques and voice transmissions.

While other techniques are available for this communication, one such technique is described in U.S. Pat. No. 6,728,924, issued Apr. 27, 2004, to Lou et al. and entitled, “Packet Loss Control Method for Real-time Multimedia Communications”, incorporated hereinto by reference.

This allows the “visitor” to comment with other visitors as to how they like the painting or sculpture and to engage in “small talk”.

Additionally, operators of the second computer (that projecting the virtual building and its contents) are able to browse through the “building” as well as salesmen or artists (for the paintings) and provide instant assistance to the “customers” within the virtual building. In this manner, the purchasing experience is enhanced and more successful sales are made.

In this manner, a totally new interface for users to view and purchase art is created. Rather than viewing catalog type “pages” that have been posted on a static web site, the purchasing experience is totally virtual.

The creation of the virtual building and its attendant virtual rooms together with the virtual items is well known to those of ordinary skill in the art and are found on many of the Role Playing Games “RPG” currently available for many computers, including, but not limited to: PLAYSTATION and X-BOX.

When the customer is ready to purchase an item (such as a painting), a “buy” button is activated and the purchase is carried out through a variety of techniques well known to those ordinary skill in the art, including, but not limited to those described in U.S. Pat. No. 5,822,737, entitled “Financial Transaction System”, issued on Oct. 13, 1998, to Ogram and incorporated hereinto by reference.

The invention, together with various embodiments thereof, will be more fully explained by the accompanying drawings and the following descriptions thereof.

### DRAWINGS IN BRIEF

FIG. 1 illustrates the distributed system of computers used in the present invention.

FIG. 2 diagrams a virtual image.

FIG. 3 is a flow chart of the operation of the preferred embodiment of the invention.

### DRAWINGS IN DETAIL

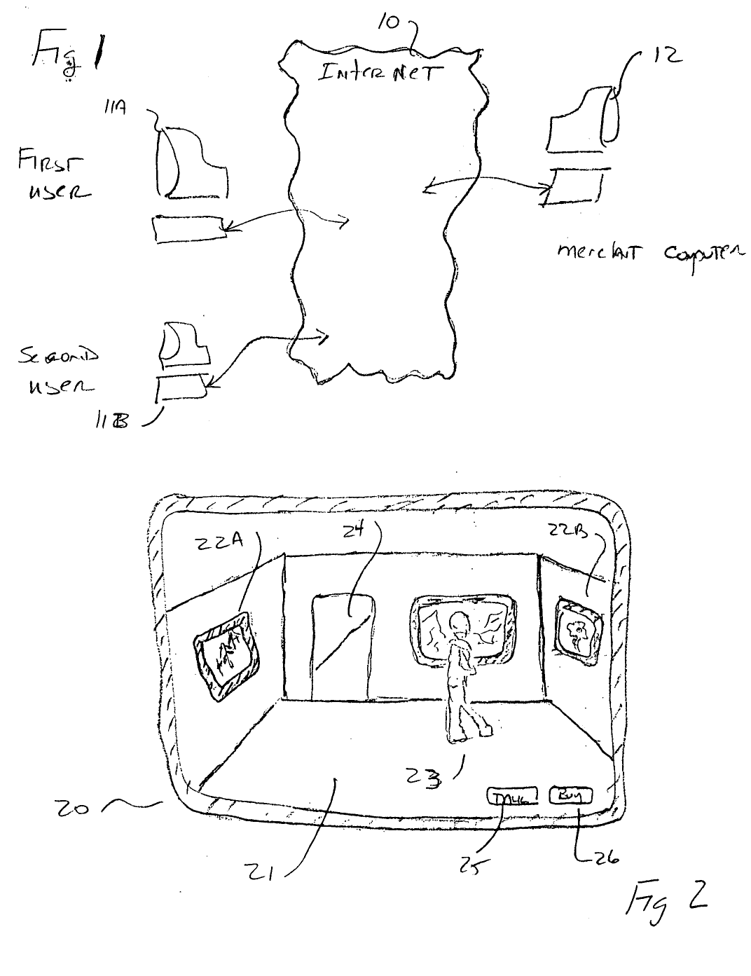

FIG. 1 illustrates the distributed system of computers used in the present invention.

In this illustration, the distributed network is Internet 10 which connects remote computers 11A and 11B with the merchant computer 12. It is the merchant computer 12 which contains the virtual building data together with the virtual item data within its memory.

When computer 11A communicates with merchant computer 12, a view of the virtual building with its associated virtual items are communicated to the user of computer 11A via Internet 10. The user of computer 11A is able to direct movement and activities “within” the virtual building by delivering input directions to merchant computer 12. In this manner, the user of computer 11A is able to “browse” through the virtual building and its items until a selection on a purchase is made or the user “leaves” the virtual building.

In a similar manner, the user of computer 11B is also able to move independently through the virtual building with the aid of merchant computer 12. Note, the images delivered to computer 11A and the images delivered to computer 11B are different since each relies upon the perspective created by the input history of the specific remote computer 11A or 11B.

Since each user has chosen their own “image” to appear within the virtual building, in some situations, the second user will appear in the image created for the first computer. This permits the first user (computer 11A) to send messages (either text or voice) to the second user (computer 11B) via the merchant computer 12.

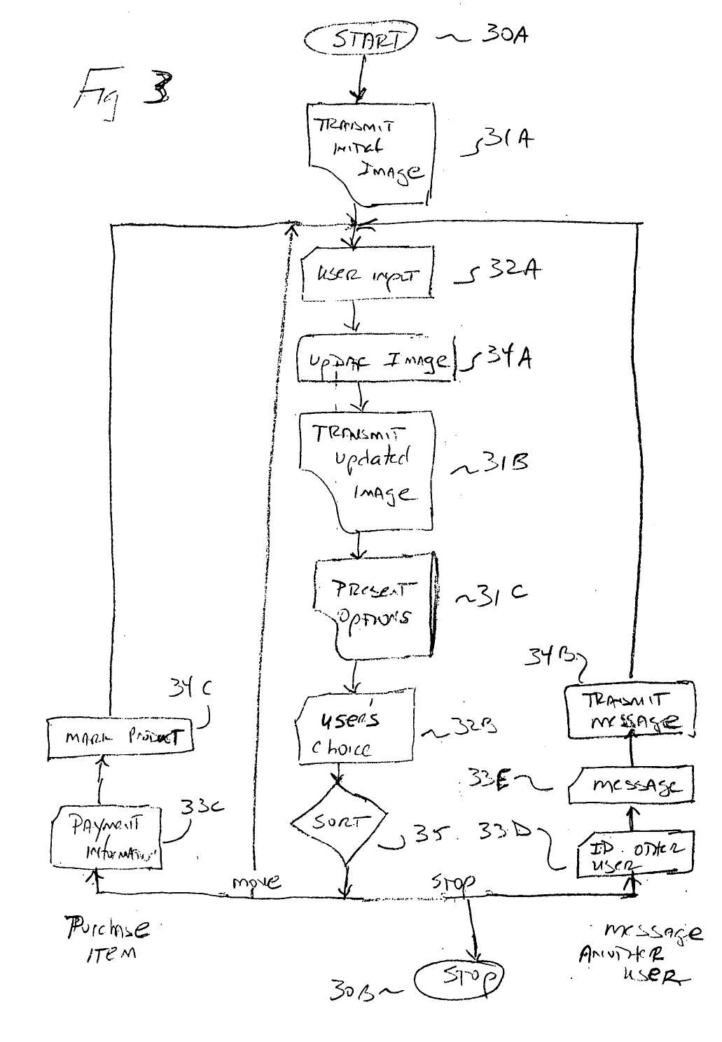

FIG. 2 diagrams a virtual image.

Following the example above of an art gallery, screen 20, associated with computer 11A of FIG. 1 shows a room 21 having various paintings (such as 22A and 22B) “hanging” on the walls of the virtual room.

The user is able to “move” through the room to get a better view of each painting or is able to “move” through doorway 24 to enter the adjoining room with its attendant paintings.

In this illustration, another user 23 is represented within room 21. With user 23 within the room, a message can be initiated by depressing button 25. The message is then entered (either through the keyboard or a microphone) and the message is communicated to user 23.

When the user is ready to purchase an item, button 26 is activated and the purchasing process is initiated.

Through this process, the user is given a virtual room to browse and make their purchases.

FIG. 3 is a flow chart of the operation of the preferred embodiment of the invention. This flow chart relates to the operation of the merchant computer 12 of FIG. 1. In this flow chart, the remote user is either using computer 11A or computer 11B.

Once the programs starts 30A (when a remote user initiates entry), an initial image is transmitted to the remote user. The remote user provides an input (such as which direction to move) 32A and the image is updated 34A and transmitted 31B to the remote user.

Additionally, the options available to the remote user are transmitted 31C. These options may be to purchase a device, speak to another user, or move. The remote user provides input 32B and the program branches 35 based upon this input.

In this program, the branches available are: Purchase Item; Move; Stop; or, Message another user.

If the choice is Purchase Item, the payment information is collected 33C and the product is marked as “Sold” 34C. The program then returns to allow the user to move through virtual building 32A.

If the choice is Move, then the program loops back to accept input 32A as to the direction of movement.

If the choice is to Stop, then the program terminates 30B.

If the choice is to Message another User, the program obtains the identification of the other user 33D from the remote user and collects the message 33E from the remote user. The message is then transmitted to the remote user 34B.

In this manner, the user is able to “browse” through the virtual building, view items to be purchased, converse with other patrons, and purchase items that they wish to purchase. In this way, hundreds of patrons are able to be in the site, view objects, converse with each other, and make purchases.

It is clear the present invention provides for a highly improved commercial setting for the Internet and other distributed computer systems.

1. A network of computers comprising:
a) a distributed network permitting multiple remote computers to communicate between each other;
b) a first computer connected to said distributed network; and,
c) a second computer connected to said distributed network, said second computer having:
1) a memory containing data defining a virtual building having a plurality of virtual items within said virtual building, said virtual items having a specific location within said virtual building,
2) means for establishing a representation of a user of said first computer in a specific location within said virtual building,
3) means for communicating a virtual view from said representation of a user to a user of said first computer, and,
4) means for permitting a user of said first computer to purchase a virtual item within said virtual view.

2. The network of computers according to claim 1, wherein said second computer includes means for creating a second virtual view in response to input from the user of the first computer.

3. The network of computers according to claim 2,
a) further including a third computer connected to said distributed network; and,
b) wherein the second computer includes means for establishing a representation of a user of said third computer within said virtual view.

4. The network of computers according to claim 3, wherein the second computer includes means for establishing a first unique virtual view for a user of the first computer and a second unique virtual view for a user of the third computer.

5. The network of computers according to claim 4, wherein the second computer includes means for communicating messages from the first computer to the third computer.

6. The network of computers according to claim 5, wherein said means for communicating messages operates only if a representation of a user of the first computer is within the second unique virtual view.

7. A system of computers configured for commercial use comprising:
a) a first user computer; and,
b) a virtual mall computer having:
1) a memory containing data defining a virtual building having a plurality of virtual items within said virtual building, said virtual items having a specific location within said virtual building,
2) means for establish a representation of a user of said first user computer in a specific location within said virtual building,
3) means for communicating a virtual view from said representation of a user to a user of said first user computer, and,
4) means for permitting a user of said first user computer to purchase a virtual item within said virtual view.

8. The system of computers according to claim 7, wherein said virtual mall computer includes means for creating a second virtual view in response to input from the user of the first user computer.

9. The system of computers according to claim 8,
a) further including a second user computer; and,
b) wherein the virtual mall computer includes means for establishing a representation of a user of said third computer within said virtual view.

10. The system of computers according to claim 9, wherein the virtual mall computer includes means for establishing a first unique virtual view for a user of the first user computer and a second unique virtual view for a user of the second user computer.

11. The system of computers according to claim 10, wherein the virtual mall computer includes means for communicating messages from the first user computer to the second user computer.

12. The system of computers according to claim 11, wherein said means for communicating messages operates only if a representation of a user of the first user computer is within the second unique virtual view.

13. A commercial network of computers comprising:
a) a distributed network allowing computers to communicate therebetween;
b) a commercial computer connected to said distributed network, said commercial computer having:
1) a memory containing data defining a virtual building having a plurality of virtual items within said virtual building, said virtual items having a specific location within said virtual building,
2) means for establish a representation of a user of a first inquiring computer in a specific location within said virtual building,
3) means for communicating a virtual view from said representation of a user to a user of said first inquiring computer, and,
4) means for permitting a user of said first inquiring computer to purchase a virtual item within said virtual view.

14. The commercial network of computers according to claim 13, wherein said commercial computer includes means for creating a second virtual view in response to input from the user of the first inquiring computer.

15. The commercial network of computers according to claim 14, wherein the commercial computer includes means for establishing a representation of a user of a second inquiring third computer within said virtual view.

16. The commercial network of computers according to claim 15, wherein the commercial computer includes means for establishing a first unique virtual view for a user of the first inquiring computer and a second unique virtual view for a user of the second inquiring computer.

17. The commercial network of computers according to claim 16, wherein the commercial computer includes means for communicating messages from the first inquiring computer to the second inquiring computer.
